(19) United States
(12) Patent Application Publication
(10) Pub. No.: US 2017/0353022 A1
(43) Pub. Date: Dec. 7, 2017

(54) CONNECTOR

(71) Applicant: MOLEX, LLC, LISLE, IL (US)

(72) Inventor: TOSHIHIRO NIITSU, TOKYO (JP)

(73) Assignee: MOLEX, LLC, LISLE, IL (US)

(21) Appl. No.: 15/581,733

(22) Filed: Apr. 28, 2017

(30) Foreign Application Priority Data
Jun. 1, 2016 (JP) 2016-109905

(51) Int. Cl. H02G 3/06; F16L 37/098

(52) U.S. Cl. CPC H02G 3/0616; F16L 37/0987

(57) ABSTRACT

A connector is provided which has first and second connectors. The first connector includes a first connector including a first housing. The first housing includes a substantially cylindrical first mating portion formed on a front end thereof. The second connector includes a second housing configured to be mated with the first housing. The second housing includes a substantially cylindrical second mating portion formed on a front end thereof. The second mating portion configured to receive the first mating portion. The second mating portion further includes a separating space, a mating main body portion separated by the separating space, and a mating main body deformation restricting portion. The mating main body deformation restricting portion is configured to restrict the amount of deformation of the mating main body portion.

### RELATED APPLICATIONS

This application claims priority to Japanese Application No. 2016-109905, filed Jun. 1, 2016, which is incorporated herein by reference in its entirety.

### TECHNICAL FIELD

The present disclosure relates to a connector.

### BACKGROUND ART

A technique has been proposed in which the insulating tubes covering cables to be connected to each other are made so that the insulating tubes can be connected to each other (see, for example, Patent Document 1).

FIG. 8 is a drawing showing the structure used to connect insulating tubes to each other in the prior art.

In this drawing, 811 is an insulating tube made of an insulating resin material, which is a tube-shaped member covering the outer periphery of an electric cable (not shown). Also, 821 is tube-shaped elastic member made of an insulating resin material which is mounted on the inside surface of the insulating tube 811 to grip the electric cable provided inside the insulating tube on the periphery. The tube-shaped elastic member 821 is preferably integrated with the insulating tube 811.

On the other side, 911 is an opposing insulating tube made of an insulating resin material, which is a tube-shaped member covering the outer periphery of an electric cable (not shown). Also, 921 is opposing tube-shaped elastic member made of an insulating resin material which is mounted on the inside surface of the opposing insulating tube 911 to grip the electric cable provided inside the insulating tube on the periphery. The opposing tube-shaped elastic member 921 is preferably integrated with the opposing insulating tube 911.

A mating recessed portion 825 is formed on the inner surface in the tip portion of the insulating tube 811, and a mating protruding portion 925 is formed on the outer surface in the tip portion of the opposing insulating tube 911. When the tip portion of the opposing insulting tube 911 is inserted into and mated with the tip portion of the insulating tube 811, the mating recessed portion 825 is mated with the mating protruding portion 925. The tip portion of the opposing insulating tube 911 is formed so that the diameter narrows, thereby enabling it to be inserted into the tip portion of the insulating tube 811. In this way, the insulating tube 811 and the opposing insulating tube 911 are reliably connected.

Patent Document 1: Laid-Open Patent Publication No. 2012-210071

### SUMMARY

In the connecting structure of the prior art, the mating recessed portion 825 and the mating protruding portion 925 are unlikely to become unmated when pulling force, that is, detaching force, is applied in the longitudinal direction of the insulating tube 811 and the opposing insulating tube 911. However, the mating recessed portion 825 and the mating protruding portion 925 are more likely to become unmated and disconnected when detaching force is applied obliquely to the insulating tube 811 and the opposing insulating tube 911 due to leverage.

Therefore, it is an object of the present disclosure to solve the problem associated with the prior art by providing a highly reliable connector with a simple configuration which does not become easily unmated even when detaching force is applied in an oblique direction.

The present disclosure is a connector comprising a first connector including a first housing and a second connector including a second housing to be mated with the first housing, the first housing including a substantially cylindrical first mating portion formed on the front end, the second housing including a substantially second mating portion formed on the front end and able to receive the inserted first mating portion, and the second mating portion also including a separating space, a mating main body portion separated by the separating space, and a mating main body deformation restricting portion for restricting the amount of deformation of the mating main body portion.

In another connector, the first mating portion includes a first engaging portion formed on the outer periphery thereof, and the second mating portion includes a second engaging portion formed on the inner periphery thereof and able to engage the first engaging portion.

In yet another connector, the separating space is a slit-like space extending in the mating direction of the second mating portion, the mating main body portion is positioned inside the separating space, and the mating main body restricting portion is positioned outside the separating space.

In still another connector, the separating space is a cylindrical space surrounding the entire outer periphery of the mating main body portion, and the mating main body restricting portion surrounds the entire outer periphery of the separating space.

This connector does not become easily unmated even when detaching force is applied in an oblique direction. The result is a more reliable connector with a simple configuration.

### BRIEF DESCRIPTION OF THE DRAWINGS

FIGS. 1A-1C are a set of three views showing a first connector mated with a second connector in an embodiment of the present disclosure, in which FIG. 1A is a rear view of the second connector, FIG. 1B is a side view, and FIG. 1C is a rear view of the first connector.

FIG. 2 is a cross-sectional view from arrows A-A in FIG. 1B showing the first connector mated with the second connector in the embodiment.

FIGS. 3A-3C are a set of three views showing the first housing of the first connector in the embodiment, in which FIG. 3A is a front view, FIG. 3B is a side view, and FIG. 3C is a rear view.

FIGS. 4A and 4B are a pair of views showing the first housing of the first connector in the embodiment, in which FIG. 4A is a perspective view from the front and FIG. 4B is a cross-sectional view from arrows B-B in FIG. 3B.

FIGS. 5A-5C are a set of three views showing the second housing of the second connector in the embodiment, in which FIG. 5A is a rear view, FIG. 5B is a side view, and FIG. 5C is a front view.

FIGS. 6A and 6B are a pair of views showing the second housing of the second connector in the embodiment, in which FIG. 6A is a perspective view from the rear and FIG. 6B is a cross-sectional view from arrows C-C in FIG. 5B.

FIG. 7 is a partial cross-sectional view corresponding to FIG. 2 showing the first housing mated with the second housing in the embodiment.

FIG. 8 is a drawing showing the structure used to connect insulating tubes to each other in the prior art.

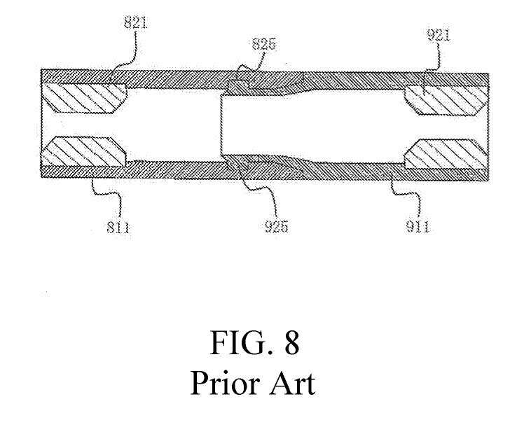

### DETAILED DESCRIPTION OF THE PREFERRED EMBODIMENTS

The following is a detailed explanation of an embodiment with reference to the drawings.

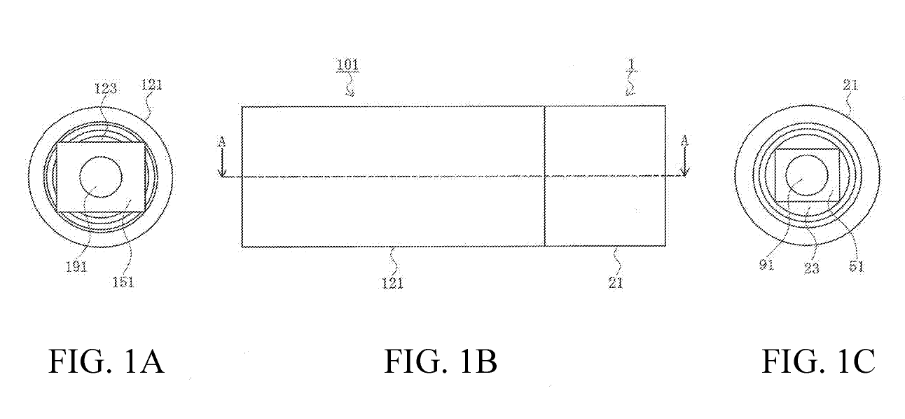

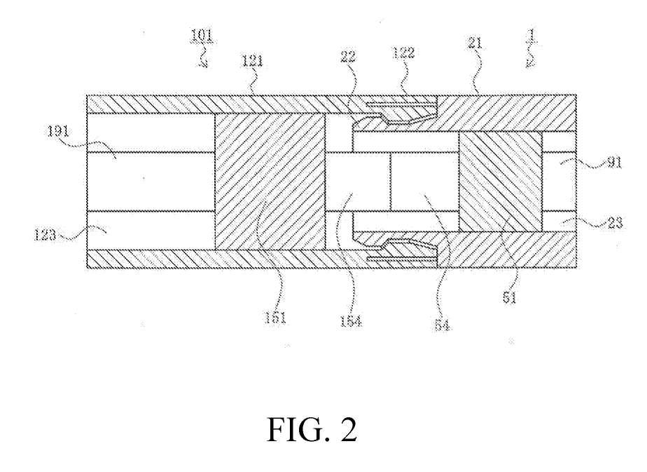

FIGS. 1A-1C are a set of three views showing a first connector mated with a second connector in an embodiment of the present disclosure, and FIG. 2 is a cross-sectional view from arrows A-A in FIG. 1B showing the first connector mated with the second connector in the embodiment. FIG. 1A is a rear view of the second connector, FIG. 1B is a side view, and FIG. 1C is a rear view of the first connector.

In these drawings, 1 is the first connector in the embodiment and 101 is the second connector in the embodiment. As shown in the figures, the first connector 1 and the second connector 101 are mated with each other and connected.

The connectors in the present embodiment can be any type of connector used for any type of application. For example, the first connector 1 and the second connector 101 may be board connectors mounted on the surface of a board such as a printed circuit board. One of the connectors may be a socket (or receptacle) mounted on a room wall (or panel) in a building and the other may be a plug connected to the end of a cable or wire. Alternatively, one of the connectors may be a board connector mounted on the surface of a board and the other may be a plug connected to the end of a cable or wire. In the following explanation, for sake of convenience, the first connector 1 is a cable connector connected to the tip of a first electric cable 91 and the second connector 101 is a cable connector connected to the tip of a second electric cable 191.

In the present embodiment, the expressions indicating direction, such as upper, lower, left, right, front and rear, which are used to explain the configuration and operation of the first connector 1 and the second connector 101 are relative and not absolute. They depend on the orientation of the first connector 1, the second connector 101, and their constituent components shown in the drawings. When the orientation of the first connector 1, the second connector 101, or their constituent components changes, the interpretation changes in response to the change in orientation.

The first connector 1 is molded integrally from an insulating material such as a synthetic resin, and includes a first housing 21 mated with a second housing 121 of the second connector 101, a first connector main body portion 51 mounted in the first housing 21, and a substantially cylindrical first connecting portion 54 extending from the front end of the first connector main body portion 51. A first electric cable 91 is connected to the rear end of the first connector main body portion 51. The first electric cable 91 is usually a long member extending to the rear of the first housing 21. However, in the drawings, the portion extending to the rear of the first housing 21 (to the right in FIG. 2) has been omitted.

The first housing 21 is a substantially cylindrical member extending in the mating direction of the second connector 101, that is, in the longitudinal direction of the first connector 1. The first housing 21 includes a first interior space 23 passing through the first housing 21 in the longitudinal direction, and a first mating portion 22 formed in the front end (the left end in FIG. 2).

The first connector main body portion 51 is housed inside the first interior space 23 and fixed to the first housing 21. In the example shown in the drawings, the first connecting portion 54 may be positioned entirely inside the first interior space 23, and the tip (the left end in FIG. 2) may protrude forward from the front of the first interior space 23 (to the left in FIG. 2).

The first connecting portion 54 can be any type of connector as long as electrical contact can be made with a second connecting portion 154 in the second connector 101. For example, it may be a plurality of protruding terminals, a plurality of cylindrical terminals for receiving inserted terminals on another connector, a plurality of band-shaped terminals, or a plurality of spherical or hemispherical terminals. The first connector main body portion 51 has a conductive trace connecting each terminal in the first connecting portion 54 to a wire in the first electric cable 91.

The second connector 101 is molded integrally from an insulating material such as a synthetic resin, and includes a second housing 121 mated with the first housing 21 of the first connector 1, a second connector main body portion 151 mounted in the second housing 121, and a second connecting portion 154 extending from the front end of the second connector main body portion 151. A second electric cable 191 is connected to the rear end of the second connector main body portion 151. The second electric cable 191 is usually a long member extending to the rear of the second housing 121 (to the left in FIG. 2). However, in the drawings, the portion extending to the rear of the second housing 121 has been omitted.

The second housing 121 is a substantially cylindrical member extending in the mating direction of the first connector 1, that is, in the longitudinal direction of the second connector 101. The second housing 121 includes a second interior space 123 passing through the second housing 121 in the longitudinal direction, and a second mating portion 122 formed in the front end (the right end in FIG. 2).

The second connector main body portion 151 is housed inside the second interior space 123 and fixed to the second housing 121. In the example shown in the drawings, the second connecting portion 154 may be positioned entirely inside the second interior space 123, and the tip (the right end in FIG. 2) may protrude forward from the front of the second interior space 123 (to the right in FIG. 2). In the example shown in FIG. 2, the first mating portion 22 of the first housing 21 is inserted into the second mating portion 122 of the second housing 121, so the tip of the second connecting portion 154 can be seen protruding forward from the second interior space 123.

The second connecting portion 154 can be any type of connector as long as electrical contact can be made with the first connecting portion 54 in the first connector 1. For example, it may be a plurality of protruding terminals, a plurality of cylindrical terminals for receiving inserted terminals on another connector, a plurality of band-shaped terminals, or a plurality of spherical or hemispherical terminals. The second connector main body portion 151 has a conductive trace connecting each terminal in the second connecting portion 154 to a wire in the second electric cable 191.

The following is a detailed explanation of the configuration of the first housing 21.

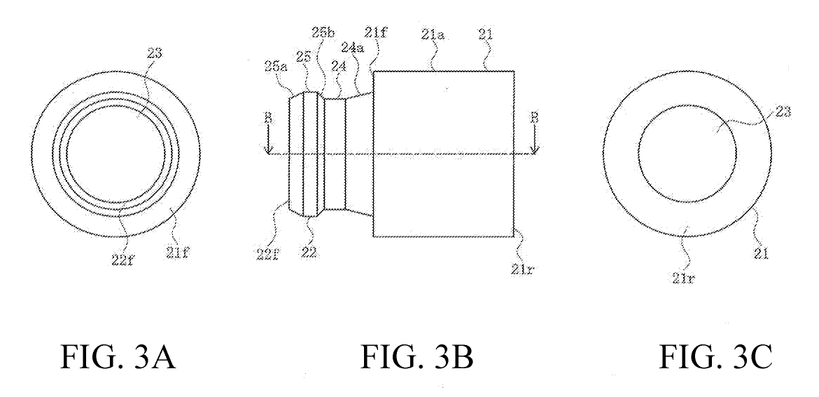

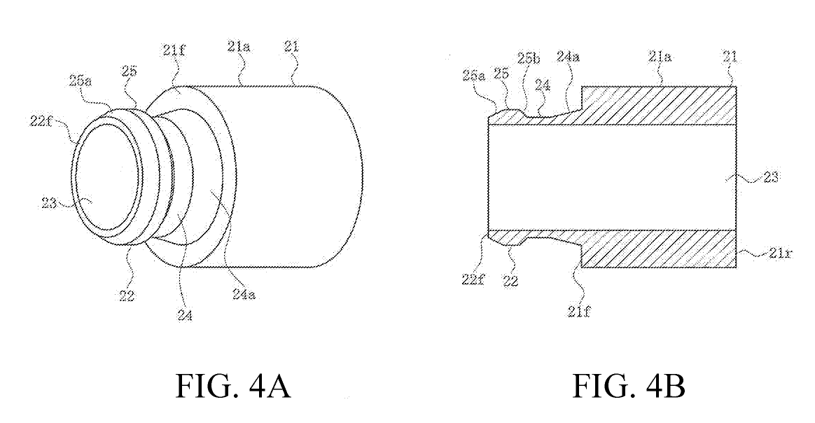

FIGS. 3A-3C are a set of three views showing the first housing of the first connector in the embodiment, and FIGS. 4A and 4B are a pair of views showing the first housing of the first connector in the embodiment. FIG. 3A is a front view, FIG. 3B is a side view, and FIG. 3C is a rear view. FIG. 4A is a perspective view from the front and FIG. 4B is a cross-sectional view from arrows B-B in FIG. 3B.

In the example shown in the drawings, the first mating portion 22 is formed so as to protrude forward (to the left in FIG. 3B) from the front end portion 21f of the main body portion 21a of the first housing 21, and so as to have an outer diameter that is smaller than the outer diameter of the main body portion 21a. The first interior space 23 is a cylindrical space with a fixed inner diameter along its entire length, which extends from the rear end portion 21r of the main body portion 21a to the front end portion 22f of the first mating portion 22. The front end portion 22f of the first mating portion 22 is substantially the front end portion of the first housing 21.

The first mating portion 22 has a first protruding portion 25 formed near the front end portion 22f serving as the first engaging portion, and a first recessed portion 24 formed near the front end portion 21f of the main body portion 21a adjacent to the first protruding portion 25. The outer diameter of the first protruding portion 25 is greater than the outer diameter of the first recessed portion 24, and the first mating portion 22 has an undulating outer profile from the rear to the front. The outer diameter of the first protruding portion 25 is smaller than the outer diameter of the main body portion 21a.

The section of the first protruding portion 25 near the front end portion 22f is a tapered front side inclined portion 25a whose outer diameter becomes smaller towards the front end portion 22f, and the section of the first protruding portion 25 near the first recessed portion 24 is a tapered rear side inclined portion 25b whose outer diameter becomes smaller towards the first recessed portion 24. The section of the front protruding portion 25 between the front side inclined portion 25a and the rear side inclined portion 25b has an outer diameter whose dimensions remain nearly constant. Also, the section of the first recessed portion 24 near the front end portion 21f of the main body portion 21a is a tapered rear side inclined portion 24a whose diameter becomes larger towards the front end portion 21f. The section of the first recessed portion 24 in front of the rear side inclined portion 24a has an outer diameter whose dimensions remain nearly constant. Also, the inclination of the rear side inclined portion 25b of the first protruding portion 25 is more steep than the inclination of the front side inclined portion 25a and the rear side inclined portion 24a of the first recessed portion 24.

The following is a detailed explanation of the configuration of the second housing 121.

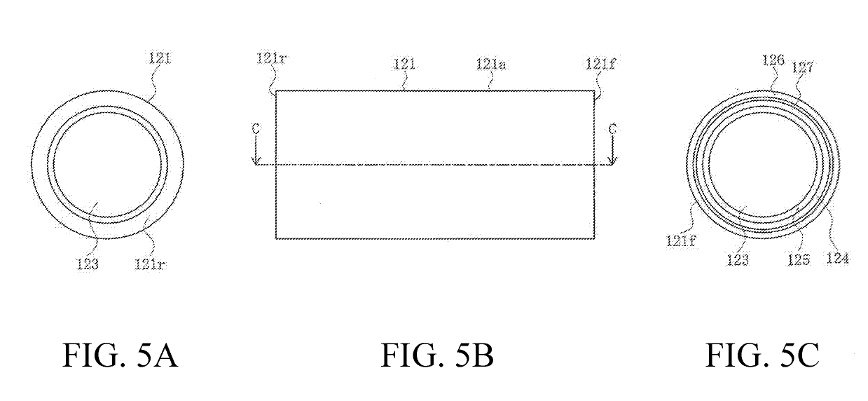

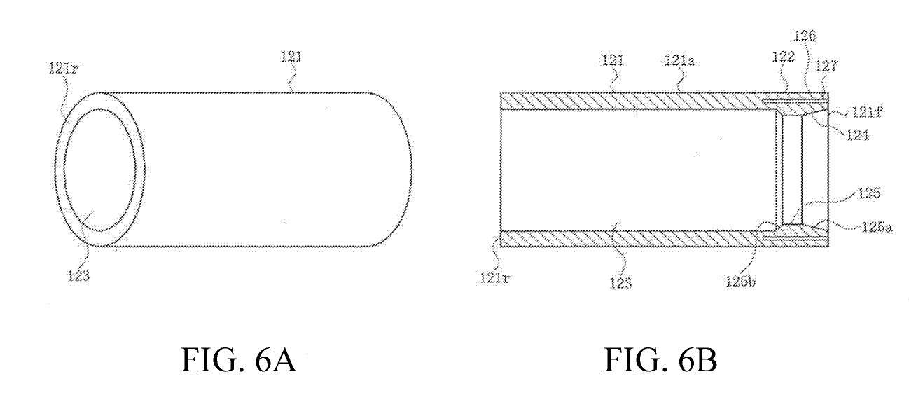

FIGS. 5A-5C are a set of three views showing the second housing of the second connector in the embodiment, and FIGS. 6A and 6B are a pair of views showing the second housing of the second connector in the embodiment. FIG. 5A is a rear view, FIG. 5B is a side view, and FIG. 5C is a front view. FIG. 6A is a perspective view from the rear and FIG. 6B is a cross-sectional view from arrows C-C in FIG. 5B.

In the example shown in the drawings, the second mating portion 122 is a portion formed along a predetermined length and facing rearward (to the left in FIG. 5B) from the front end portion 121f of the main body portion 121a of the second housing 121. The outer diameter is the same as the outer diameter of the main body portion 121a. In other words, the second housing 121 is a cylindrical member with a fixed outer diameter along the entire length from the rear end portion 121r to the front end portion 121f.

The second mating portion 122 has a separating space 127 which is a cylindrical slit formed so as to extend to the rear a predetermined length from the front end portion 121f, a cylindrical outer wall portion 126 positioned to the outside of the separating space 127 to serve as a mating main body deformation restricting portion, and a cylindrical inner wall portion 124 positioned to the inside of the separating space 127 to serve as a mating main body portion. In other words, the second mating portion 122 is separated by the separating space 127 into an outer wall portion 126 and an inner wall portion 124. The outer wall portion 126 and the inner wall portion 124 are integrally connected to the main body portion 121a to the rear of the separating space 127.

The inner wall portion 124 has a second protruding portion 125 formed so as to protrude inwardly as the second engaging portion. The inner diameter of the second protruding portion 125 is smaller than the inner diameter of the second interior space 123, which is a cylindrical space with a constant inner diameter in the main body portion 121a. The section of the second protruding portion 125 near the front end portion 121f is a tapered front side protruding portion 125a whose inner diameter becomes larger towards the front end portion 121a, and the section of the second protruding portion 125 near the main body portion 121a is a tapered rear side inclined portion 125b whose inner diameter becomes larger towards the main body portion 121a.

The section of the second protruding portion 125 between the front side inclined portion 125a and the rear side inclined portion 125b has an inner diameter that is substantially constant. The inclination of the rear side inclined portion 125b is more steep than the inclination of the front side inclined portion 125a.

The following is an explanation of the operations performed to mate and connect the first connector 1 and the second connector 101.

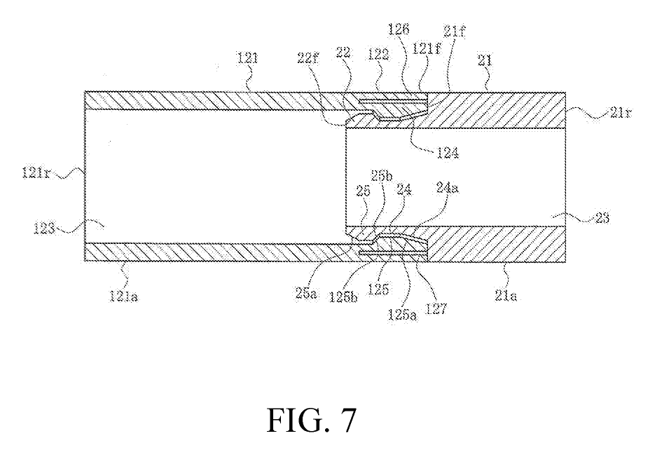

FIG. 7 is a partial cross-sectional view corresponding to FIG. 2 showing the first housing mated with the second housing in the embodiment.

When the first connector 1 and the second connector 101 are to be mated and connected, the operator manually grasps at least the first housing 21 or the second housing 121 to adjust the orientation of the connector, bring the front end portion 22f of the first mating portion 22 of the first housing 21 towards the front end portion 121f of the second housing 121, and align the central axes of the first housing 21 and the second housing 121 in the longitudinal direction. The operator then moves at least the first housing 21 or the second housing 121 along the central axes in the longitudinal direction to insert the first mating portion 22 into the second mating portion 122.

Because the outer diameter of the first protruding portion 25 of the first mating portion 22 is greater than the inner diameter of the second protruding portion 125 of the second mating portion 122, the second protruding portion 125 is pushed out in the radial direction when the first mating portion 22 advances towards the rear of the second mating portion 122. Because the second mating portion 122 is separated into an outer wall portion 126 and an inner wall portion 124 by the separating space 127, the second protruding portion 125 formed in the thin inner wall portion 124 is easily pushed out in the radial direction. Because the section of the first protruding portion 25 near the front end portion 22f forms a tapered front side inclined portion 25a and the section of the second protruding portion 125 near the front end portion 121f forms a tapered front side inclined portion 125a, the first mating portion 22 can advance smoothly into the second mating portion 122. In the example shown in the drawings, because the inclination of the front side inclined portion 125a of the second protruding portion 125 is gentle, the first mating portion 22 can advance even more smoothly into the second mating portion 122.

When the first protruding portion 25 overcomes the second protruding portion 125, as shown in FIG. 7, the first connector 1 and the second connector 101 are mated and connected to each other. In FIG. 7, for the sake of convenience, only the first housing 21 and the second housing 121 are depicted. The other components have been omitted.

When the first housing 21 and the second housing 121 have been mated and the first connector 1 and the second connector 101 are connected to each other, the first protruding portion 25 and the second protruding portion 125 are engaged, and the first mating portion 22 and the second mating portion 122 are mated in the state shown in FIG. 7. In other words, the first mating portion 22 is fitted into the second mating portion 122, the first protruding portion 25 of the first mating portion 22 engages the section of the second mating portion 122 to the rear of the second protruding portion 125, and the first recessed portion 24 of the first mating portion 22 engages the second protruding portion 125 of the second mating portion 122. Also, the rear side inclined portion 25b in the first protruding portion 25 of the first mating portion 22 engages the rear side inclined portion 125b of the second protruding portion 125 of the second mating portion 122.

More specifically, the first protruding portion 25 of the first mating portion 22 is fitted from the inside of the second mating portion 122 to the rear of the second mating portion 122, the second protruding portion 125 of the second mating portion 122 is fitted from the outside of the first mating portion 22 into the first recessed portion 24 of the first mating portion 22, and the outer peripheral surface of the first mating portion 22 and the inner peripheral surface of the second mating portion 122 make contact with each other or are close to each other along the entire length. The section of the first protruding portion 25 between the front side inclined portion 25a and the rear side inclined portion 25b and the rear side inclined portion 25b face, respectively, the section of the second mating portion 122 to the rear of the second protruding portion 125 and the rear side inclined portion 125b of the second protruding portion 125, and the rear side inclined portion 24a of the second protruding portion 125 and the section to the front of the rear side inclined portion 24a face, respectively, the front side inclined portion 125a of the second protruding portion 125 and the section between the front side inclined portion 125a and the rear side inclined portion 125b. Also, the front end portion 21f of the main body portion 21a of the first housing 21 and the front end portion 121f of the main body portion 121a of the second housing 121 make contact with each other or closely face each other.

When the first connector 1 and the second connector 101 have been connected in this manner, the first protruding portion 25 of the first mating portion 22 engages the portion of the second mating portion 122 to the rear of the second protruding portion 125, the first recessed portion 24 of the first mating portion 22 engages the second protruding portion 125 of the second mating portion 122, and the rear side inclined portion 25b of the first protruding portion 25 of the first mating portion 22 engages the rear side inclined portion 125b of the second protruding portion 125 of the second mating portion 122. Therefore, when force is applied to unmated the first connector 1 and the second connector 101, that is, when pulling force or detaching force is applied in the longitudinal direction of the first housing 21 and the second housing 121, the connectors are not easily unmated. In the example shown in the drawing, the rear side inclined portion 25b of the first protruding portion 25 of the first mating portion 22 and the rear side inclined portion 125b of the second protruding portion 125 of the second mating portion 122 engage each other at a steep inclination, they are difficult to disengage. Therefore, the first mating portion 22 and the second mating portion 122 are not easily unmated.

However, when the first connector 1 and the second connector 101 are connected, and the first connector 1 and/or the second connector 101 are tampered with, that is, detaching force is applied in an oblique direction relative to the central axis of the first connector 1 and/or the second connector 101 in the longitudinal direction, a leveraging action is produced, causing the inner wall portion 124 formed by the second protruding portion 125 to become significantly deformed, and raising concern that the first mating portion 22 and the second mating portion 122 will become unmated. However, in the present embodiment, an outer wall portion 126 is present to the outside of the inner wall portion 124, the extent of the deformation to the outside of the inner wall portion 124 is restricted by contact with the outer wall portion 126, and concern is allayed as the first mating portion 22 and the second mating portion 122 are not easily unmated.

In the example shown in the drawing, if pulling force were applied to the first housing 21 downward and to the right obliquely, turning moment would be applied to the first mating portion 22 in the clockwise direction around the lower end. This turning moment is increased even more by the leverage action when the point of action of the pulling force downward and to the right obliquely on the first housing 21 is farther from the first mating portion 22. As a result, greater force acting upward and to the right obliquely from the upper end of the first mating portion 22 is applied to the upper end of the second mating portion 122, and the upper end of the inner wall portion 124 is deformed to the outside. However, because the outer wall portion 126 is present along the entire outer periphery of the inner wall portion 124 via the separating space 127, the extent of the deformation upward on the upper end of the inner wall portion 124 is limited by contact with the outer wall portion 126 and is not significant. Therefore, the upper end of the first protruding portion 25 easily overcomes the upper end of the second protruding portion 125 and does not move to the rear (to the right in the drawing), and the first mating portion 22 and the second mating portion 122 do not easily become unmated.

Thus, the present embodiment is a connector comprising a first connector 1 including a first housing 21 and a second connector 101 including a second housing 121 to be mated with the first housing 21. The first housing 21 includes a substantially cylindrical first mating portion 22 formed on the front end, the second housing 121 includes a substantially second mating portion 122 formed on the front end and able to receive the inserted first mating portion 22, and the second mating portion 122 also includes a separating space 127, an inner wall portion 124 separated by the separating space 127, and an outer wall portion 126 restricting the extent of any deformation of the inner wall portion 124.

When the first housing 21 and the second housing 121 are mated and the first connector 1 and the second connector 101 are connected in this way, the first housing 21 and the second housing 121 do not easily become unmated even when detaching force is applied in an oblique direction. The result is a highly reliable connector with a simple configuration.

Also, the first mating portion 22 includes a first protruding portion 25 formed on the outer periphery thereof, and the second mating portion 122 includes a second protruding portion 125 formed on the inner periphery thereof and able to engage the first protruding portion 25. As a result, the first protruding portion 25 engages the second protruding portion 125, preventing unmating of the first mating portion 22 and the second mating portion 122.

In addition, the separating space 127 is a slit-like space extending in the mating direction of the second mating portion 122, the inner wall portion 124 is positioned to the inside of the separating space 127, and the outer wall portion 126 is positioned to the outside of the separating space 127. Furthermore, the separating space 127 is a cylindrical space surrounding the entire outer periphery of the inner wall portion 124, and the outer wall portion 126 surrounds the entire outer periphery of the separating space 127. Preferably, the outer wall portion 126 seamlessly surrounds the entire outer periphery of the separating space 127. Therefore, even when detaching force is applied in an oblique direction, the extent of the deformation of the inner wall portion 124 to the outside is restricted by contact with the outer wall portion 126.

In the disclosure of the present specification, characteristics related to specific preferred embodiments were described. A person of ordinary skill in the art could naturally devise other embodiments, modifications, and variations with reference to the disclosure of the present specification without departing from the spirit and scope of the appended claims.

1. A connector comprising:
a first connector including a first housing, the first housing including a substantially cylindrical first mating portion formed on a front end thereof; and
a second connector including a second housing configured to be mated with the first housing, the second housing including a substantially cylindrical second mating portion formed on a front end thereof, the second mating portion configured to receive the first mating portion, the second mating portion further including a separating space, a mating main body portion separated by the separating space, and a mating main body deformation restricting portion, the mating main body deformation restricting portion configured to restrict the amount of deformation of the mating main body portion.

2. The connector according to claim 1, wherein the first mating portion includes a first engaging portion formed on the outer periphery thereof, and the second mating portion includes a second engaging portion formed on the inner periphery thereof and able to engage the first engaging portion.

3. The connector according to claim 1, wherein the separating space is a slit-like space extending in the mating direction of the second mating portion, the mating main body portion is positioned to the inside of the separating space, and the mating main body restricting portion is positioned to the outside the separating space.

4. The connector according to claim 3, wherein the separating space is a cylindrical space surrounding the entire outer periphery of the mating main body portion, and the mating main body restricting portion surrounds the entire outer periphery of the separating space.
